(19) United States
(12) Patent Application Publication
(10) Pub. No.: US 2009/0046223 A1
(43) Pub. Date: Feb. 19, 2009

(54) RARE GAS FLUORESCENT LAMP, LAMP LIGHTING APPARATUS, AND LIQUID CRYSTAL DISPLAY DEVICE

(75) Inventors: Kiyoshi Hashimotodani, Osaka (JP); Masaki Hirohashi, Tokyo (JP)

Correspondence Address: GREENBLUM & BERNSTEIN, P.L.C., 1950 ROLAND CLARKE PLACE, RESTON, VA, 20191, US

(73) Assignee: MATSUSHITA ELECTRIC INDUSTRIAL CO., LTD., Osaka (JP)

(21) Appl. No.: 12/095,349

(22) PCT Filed: Sep. 14, 2007
(86) PCT No.: PCT/JP2007/067908

§ 371 Date: May 29, 2008

(30) Foreign Application Priority Data
Sep. 27, 2006 (JP) 2006-261986

(51) Int. Cl. G02F 1/1335; H01J 63/04

(52) U.S. Cl. 349/70; 313/491

(57) ABSTRACT

A fluorescent lamp (10) includes a discharge tube which is made of transmissive material, has a phosphor layer formed on the inner surface of the discharge tube and is filled with a discharge gas, a first internal electrode (101a) provided at one end of the discharge tube (102) for applying a rectangular alternating voltage of high frequency, a second internal electrode (101b) provided at the opposite end the discharge tube (102) to the first internal electrode (101a), an external electrode (103) provided along the longitudinal direction of the discharge tube (102). A capacitive element (104) for discharging internal charge is electrically connected to the second internal electrode (101b) outside the discharge tube (102).

### TECHNICAL FIELD

The present invention relates to a discharge light source capable of reducing environmental load without using mercury, and to a lighting apparatus for driving such a light source.

### BACKGROUND ART

Recently, as the digital television is becoming wider in screen and smaller in thickness, there is an increasing demand for larger size of liquid crystal display backlight. As the light source for liquid crystal display backlight, the conventional cold cathode fluorescent lamp is being replaced by solid light-emitting device such as light-emitting diode or organic EL element, and commercial products are partly developed. However, for the time being, the cold cathode fluorescent lamp may not be completely replaced in view of the viewpoints of efficiency of light emission, service life, and cost.

The fluorescent lamp uses a low-pressure glow discharge including mercury which is an environmental load, as an ultraviolet source for exciting phosphor as light-emitting material. In view of environmental protection, it is being desired to develop a light source having light emission efficiency equal to that of the existing fluorescent lamp without using mercury.

To achieve the purpose, it is required to develop a radiation source capable of emitting efficiently ultraviolet emission with wavelength (about 100 to 300 nm) enough to excite phosphors to radiate light effectively. Noticeable ultraviolet radiation medium other than mercury, which radiates ultraviolet by discharge, is a discharge plasma at low to medium pressure (about less than atmospheric pressure), which is mainly composed of rare gases. One photon of ultraviolet emission is finally converted to one photon of visible light by a phosphor, and the energy corresponding to the difference between ultraviolet emission energy and visible light energy makes loss. Hence, the wavelength of ultraviolet emission caused by discharge is preferred to be closer to that of visible light. Accordingly, among rare gas discharges, especially the discharge plasma which is mainly composed of xenon is considered useful since the wavelength of the radiated ultraviolet emission is relatively longer.

In xenon discharge, in particular, it is known that broad radiation efficiency is high around 172 nm, radiated upon dissociation of excimer (excited dimer) which is unstable bonding of xenon atoms in excited state and in ground state. Generally, generation, radiation, and dissociation of excimer are particularly high in efficiency in pulse after-glow. Accordingly, as compared with ordinary glow discharge, a higher efficiency is expected in the so-called dielectric barrier discharge having a dielectric layer serving as a charge barrier for cutting off current flow between the electrode and discharge space.

Therefore, regarding rare gas fluorescent lamps which using rare gas discharge caused by mainly xenon, particularly, one having a structure which uses glass tube wall of the discharge tube as dielectric layer of charge barrier has been intensively studied. As an example of such structure, the lamp disclosed in patent document 1 is shown in FIG. 10.

FIG. 10 is a sectional view of a discharge tube of a rare gas fluorescent lamp using a dielectric barrier discharge. In FIG. 10, an outer surface of the transmissive discharge tube 2 made of hard glass or the like having a phosphor layer formed inside is provided with an external electrode 3 which is coiled conductive wire of metal such as nickel. An internal electrode 1 of cold cathode is provided hermetically in and at one end of the discharge tube 2. In the discharge tube 2, a rare gas mainly composed of xenon is filled at a specified pressure. A rectangular pulse voltage of high frequency is applied between the internal electrode 1 and the external electrode 3. The outer side of the external electrode 3 is covered with a transmissive insulating tube 4 to insulate the rectangular pulse voltage from outside.

During the lamp operation, a dielectric barrier discharge is generated between the internal electrode 1 and the external electrode 3 with the tube wall of the discharge tube 2 serving as charge barrier, and the ultraviolet emission is efficiently radiated from the filled rare gas such as xenon. This excites the phosphor layer to emit light.

Patent Document 1: JP-A-2002-042737

### DISCLOSURE OF INVENTION

### Problems to be Solved by Invention

In the configuration shown in FIG. 10, when the overall length of the discharge tube 2 is long, the luminance distribution in the longitudinal direction is not uniform. That is, at a portion far from the internal electrode 1, enough electric field intensity for discharging the rare gas and generating ultraviolet emission of sufficient strength is not obtained, and thus the luminance is lowered. To avoid this problem, if the voltage to be applied to the internal electrode 1 is raised, the luminance is raised at a portion far from the internal electrode 1, but the discharge current increases. Thus, the discharge near the internal electrode 1 shrinks, and the ultraviolet emission radiation efficiency drops, resulting in lowered luminance. For a liquid crystal display backlight for a television which strongly requires uniform brightness on the screen, it is a serious problem that the luminance is not uniform in the longitudinal direction of the discharge tube 2. To avoid this, patent document 1 changes winding pitch of the coiled external electrode 3. It narrows the winding pitch of an area from a portion of the internal electrode 1 and near the internal electrode 1 to a portion far from the internal electrode 1 where the luminance is lowered. Thus the electric power provided per unit length is locally intensified and the luminance is raised, making the luminance distribution uniform.

In this method, however, an excessive electric power is applied to especially a portion near the internal electrode 1 in which ultraviolet emission efficiency is lower, and therefore the overall efficiency is lowered. When the length of the discharge tube 2 is changed depending on the television screen size, or the electric power provided to the backlight is changed by dimming according to the screen, a luminance is required to be kept uniform. However, such design of winding pitch of the external electrode 3 is extremely difficult, and it lacks flexibility in practical use.

The invention is directed to solve the above problems, and has a purpose to provide a rare gas fluorescent lamp which uses no mercury and is capable of providing uniform luminance distribution in the longitudinal direction even at low driving voltage and a lighting apparatus of the rare gas fluorescent lamp.

### Solving Means

A lamp lighting apparatus according to the invention includes a fluorescent lamp, and a power supply circuit for supplying a driving voltage to the fluorescent lamp. The fluorescent lamp includes a discharge tube made of transmissive material having a phosphor layer formed on the inner surface of the discharge tube and filled with a discharge gas, a first internal electrode provided inside the discharge tube and at one end of the discharge tube, for applying a rectangular alternating voltage of high frequency, a second internal electrode provided inside the discharge tube and at the opposite end the discharge tube to the first internal electrode, an external electrode provided along the longitudinal direction of the discharge tube, and a capacitive element for discharging internal charge which is electrically connected to the second internal electrode.

A fluorescent lamp according to the invention includes a discharge tube made of transmissive material having a phosphor layer formed on the inner surface of the discharge tube and filled with a discharge gas, a first internal electrode provided inside the discharge tube and at one end of the discharge tube, for applying a rectangular alternating voltage of high frequency, a second internal electrode provided inside the discharge tube and at the opposite end the discharge tube to the first internal electrode, an external electrode provided along the longitudinal direction of the discharge tube, and a capacitive element for discharging internal charge which is electrically connected to the second internal electrode.

A liquid crystal display device according to the invention includes a liquid crystal display panel and a backlight device for illuminating the liquid crystal display panel. The backlight device includes the lamp lighting apparatus as described above.

### EFFECT OF THE INVENTION

The invention controls amount of residual charge inside the discharge tube by discharging the residual charge in discharge process to outside of the discharge tube through the capacitive internal charge discharge element. This lowers conductivity of the plasma when inverting the polarity at the dielectric barrier discharge, so that the discharge efficiency may be uniform throughout the overall length of the discharge tube. AS a result, a rare gas fluorescent lamp for backlight capable of providing uniform luminance distribution in the longitudinal direction of the discharge tube and has good efficiency is achieved.

### BRIEF DESCRIPTION OF DRAWINGS

FIG. 1 is a perspective view of a rare gas fluorescent lamp according to the first embodiment of the invention.

FIG. 2 is a graph showing the effect of the invention.

FIG. 3 is a schematic diagram explaining a state of discharge of the rare gas fluorescent lamp of the invention.

FIG. 4 is a schematic diagram of configuration of electric circuit in the first embodiment of the invention.

FIG. 5 is a schematic diagram showing a measuring method of electric capacity in the invention.

FIG. 6 is a diagram showing an example of V-Q Lissajous' diagram in measurement of electric capacity.

FIG. 7 is a diagram showing an example of measurements of capacity, indicating an effect of the invention.

FIG. 8 is a perspective view of a liquid crystal display backlight unit in the second embodiment of the invention.

FIG. 9 is a diagram showing a configuration of a liquid crystal display device in the second embodiment of the invention.

FIG. 10 is a diagram showing a configuration of a rare gas fluorescent lamp in a prior art.

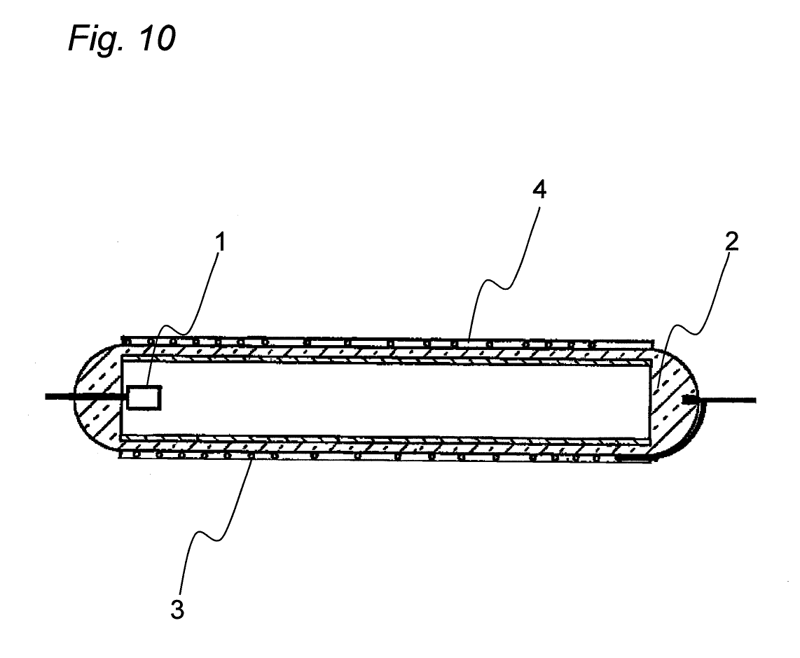

### REFERENCE NUMERALS

1, 101 Internal electrode
10 Rare gas fluorescent lamp
101a Internal electrode for driving
101b Internal electrode for adjusting internal charge
2, 102 Discharge tube
3, 103 External electrode
104 Conductive member acting as internal charge adjusting means
200 Power supply circuit
250 Lamp lighting apparatus
300 Liquid crystal display backlight unit
400 Liquid crystal display panel
430 Liquid crystal display panel driving circuit
450 Backlight device
500 Liquid crystal display device
X Internal charge discharge element
Y quasi lamp capacity

### BEST MODE FOR CARRYING OUT THE INVENTION

Preferred embodiments of the invention are described below with reference to the accompanying drawings.

### First Embodiment

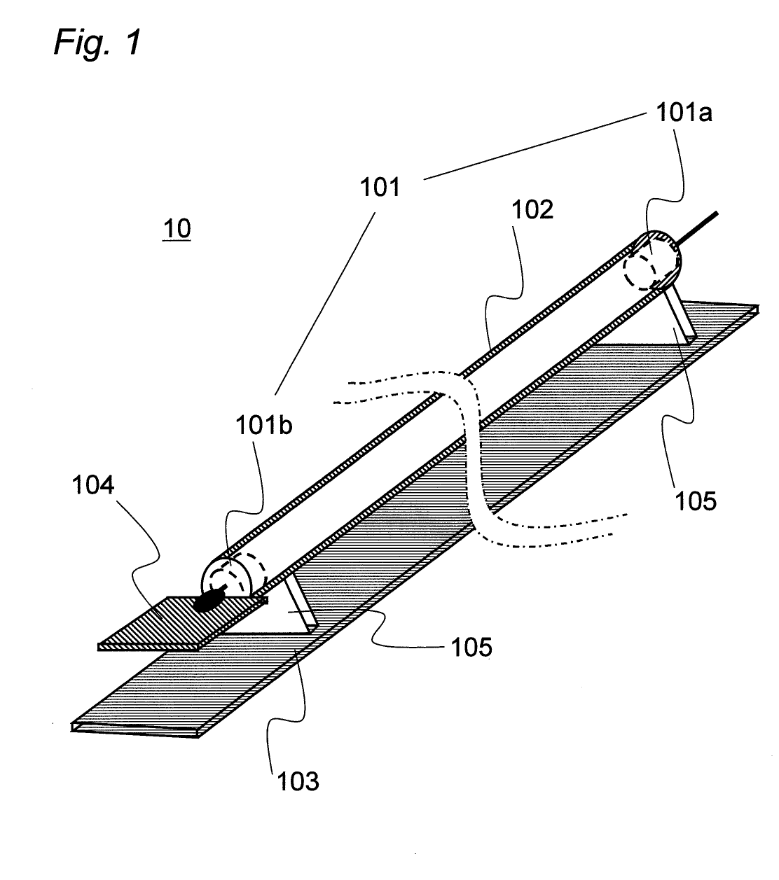

FIG. 1 is a diagram showing a configuration of a rare gas fluorescent lamp in the first embodiment of the invention. In FIG. 1, a discharge tube 102 is a cylindrical tube made of hard glass having light transparency such as borosilicate glass. Inner surface of the discharge tube 102 is provided with phosphor layers (not shown) for three wavelengths, which are selected so that the excitation spectrum may be particularly strong in vacuum ultraviolet region (mainly 200 nm or less). The discharge tube 102 is filled with a discharge gas, which is a rare gas mainly composed of xenon at pressure of about 16 kPa at ordinary temperature. At both ends of the discharge tube 102, internal electrodes 101 (101a, 101b) which are cup-shaped cold cathodes are provided hermetically inside the discharge tube 102. The first and second internal electrodes 101 (101a, 101b) are made of metal of high melting point and high electric conductivity such as nickel.

The discharge tube 102 is held at a distance of 3.0 mm (the shortest distance between the outer surface of the discharge tube 102 and the external electrode 103) from a flat-shaped external electrode 103 made of aluminum material, by spacers 105 made of insulating member such as silicone resin. The surface of the external electrodes 103 is treated by high luminance reflection coating. The term “flat-shaped” does not always mean to be perfectly flat. For example, it allows a shape having a width larger than the diameter of the discharge tube 102 and a carved shape with a radius of curvature larger than the distance to the axis of the discharge tube 102.

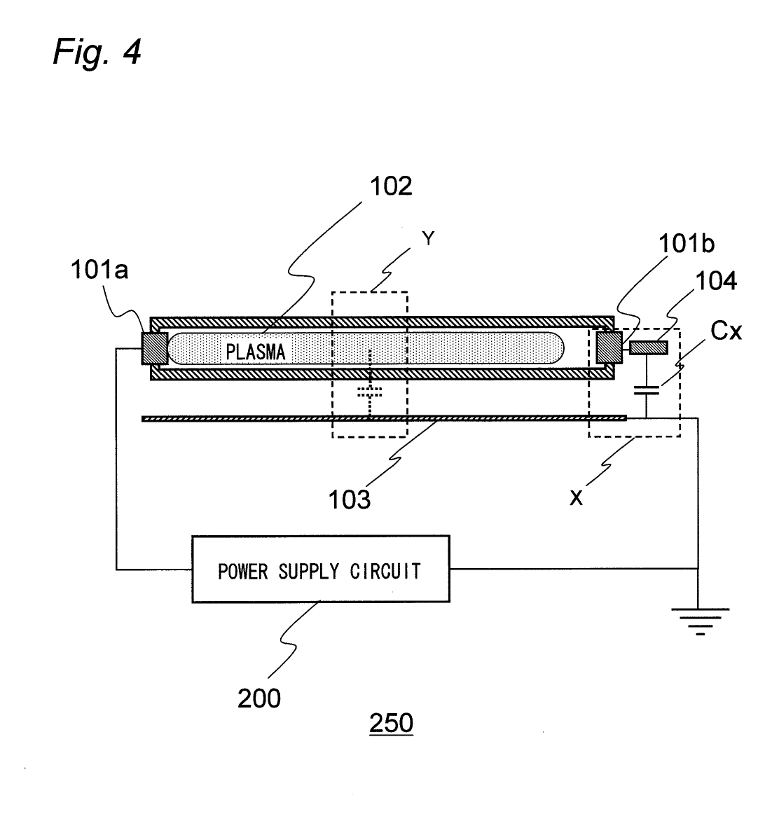

The one 101a of the internal electrodes 101 is used as an internal electrode for driving (referred to as “driving internal electrode”). A rectangular alternating voltage of 20 kHz in frequency is applied between the driving internal electrode 101a and the external electrode 103 from a power supply circuit for lighting lamp (not shown in FIG. 1, see FIG. 4). In this case, the external electrode 103 is preferably set at reference potential (grounding potential) for the sake of safety. While the voltage is applied, since the glass tube wall of the discharge tube 102 acts as a charge barrier, a dielectric barrier discharge is realized between the driving internal electrode 101a and the external electrode 103.

At the opposite end of the discharge tube 102 to the driving internal electrode 101a, an internal electrode 101b for adjusting an internal charge (referred to as “adjusting internal electrode”) having cup-shaped cold cathode similar to the driving internal electrode 101a is provided in the discharge tube 102. The adjusting internal electrode 101b is connected electrically and physically to the conductive member 104 at outside of the discharge tube 102, serving as an internal charge discharge element. The internal charge discharge element has a function of discharging outside the electric charge accumulated at the end of the discharge tube 102. The conductive member 104 is a flat member having conductivity and disposed in a plane parallel to the external electrode 103. Herein, both the adjusting internal electrode 101b and the conductive member 104 are set at floating potential. Preferably, the conductive member 104 is made from an aluminum plate of about 1 cm² in area with the distance to the external electrode 103 of about 4.5 mm.

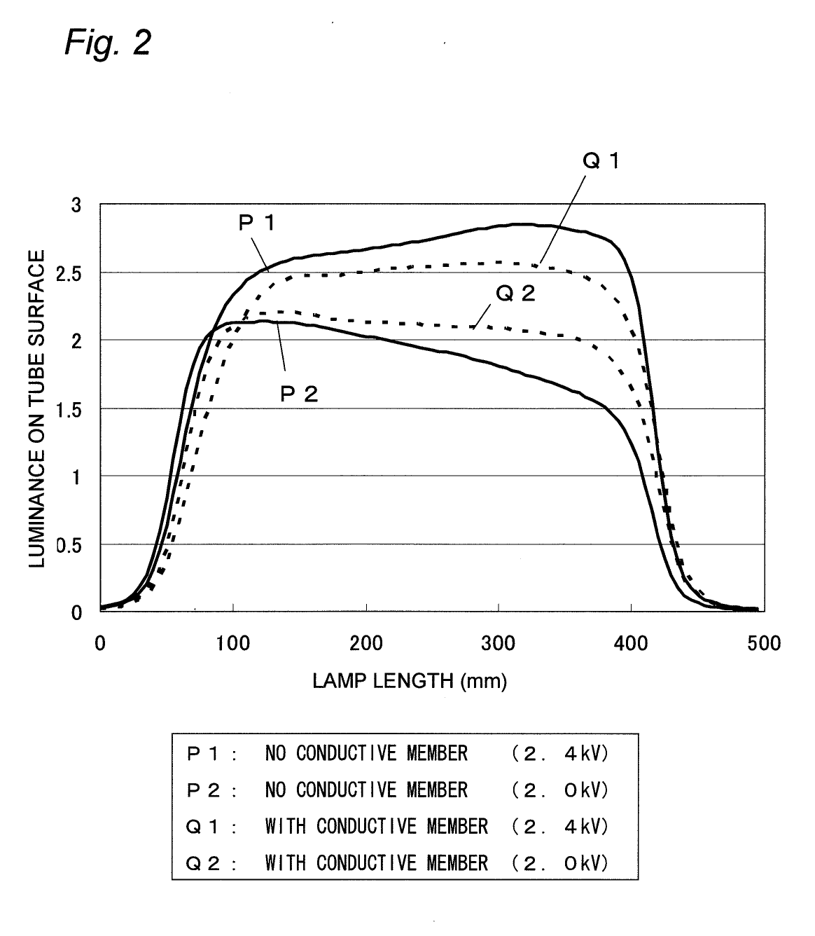

FIG. 2 shows measuring results of luminance distribution in the longitudinal direction of the rare gas fluorescent lamp according to the first embodiment. For comparison, the figure shows measuring results for cases the conventional structure not using the internal charge discharge element including the conductive member 104, and for the other cases for structure of the present embodiment (the present invention) using the conductive member 104. The solid line (curves P1, P2) represents the conventional structure not having conductive member 104, and the broken line (curves Q1, Q2) shows the results by the invention having the conductive member 104 (area 1 cm²). At applied voltage of 2.0 kV₀₋ₚ, when conductive member 104 is not connected, evidently, the luminance is higher at the side of the driving internal electrode 101a, and the luminance is lower at the side of the adjusting internal electrode 101b. That is, the applied voltage is insufficient. By contrast, when the conductive member 104 is connected, at the same applied voltage of 2.0 kV₀₋ₚ, almost uniform distribution of luminance is achieved. To evaluate the uniformity of luminance, luminance on tube surface at the flat portion shown in FIG. 2 is fitted with a straight line, and its slope is determined. As a result, it is −0.015 without the conductive member 104, and it is improved to +0.0009 with the conductive member 104. It is found that in visual evaluation, the slope of luminance begins to be recognized when the slope is larger than about +0.001. That is, it is found that use of a simple configuration as shown in the present embodiment allows the luminance distribution in the longitudinal direction of the rare gas fluorescent lamp to be made uniform without increasing the applied voltage.

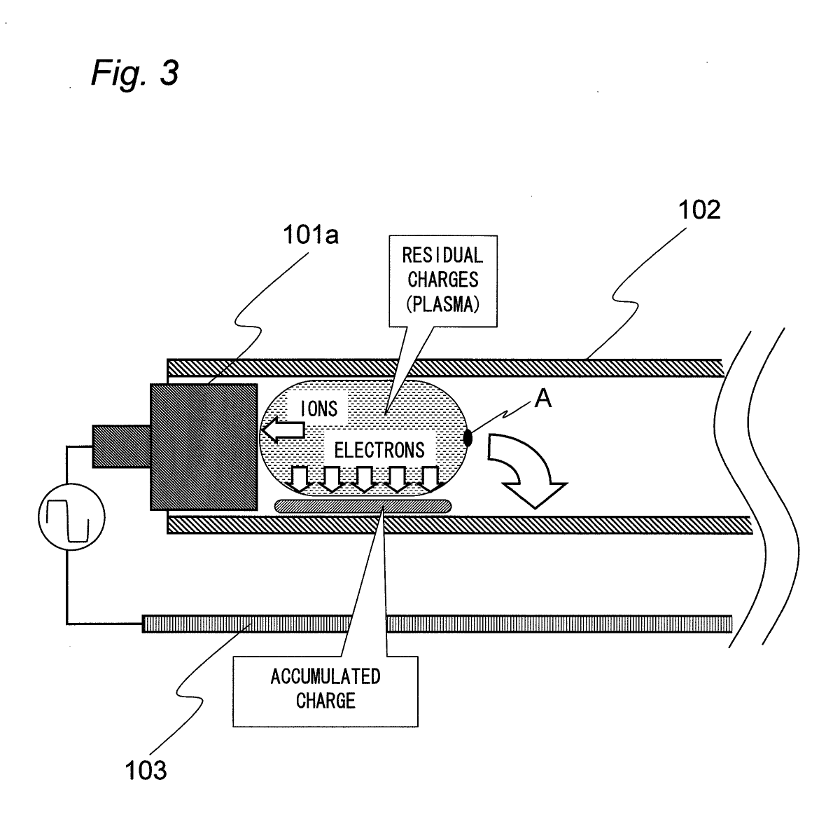

For understanding of such effect, progress of dielectric barrier discharge between the driving internal electrode 101a and the external electrode 103 is explained briefly with reference to FIG. 3. FIG. 3 shows, for example, the state of phase in which the potential of the driving internal electrode 101a changes from positive to negative. It may be considered that the same is true for the phase in which the polarity changes reversely.

As the applied voltage of the driving internal electrode 101a becomes higher and the discharge gas is broken in insulation, firstly, the discharge is started near the internal driving electrode 101a at which electric field intensity is highest. As the discharge is started, a plasma is generated inside the discharge tube 102. Positive and negative charges in the plasma (mainly ions and electrons) drift to the driving internal electrode 101a and the external electrode 103 respectively in the space in the discharge tube 102 by the electric field between the driving internal electrode 101a and external electrode 103, and hence a lamp current flows. The electric charge (electron) drifting to the side of the external electrode 103 is accumulated on the tube wall of the discharge tube 102 because the tube wall of the discharge tube 102 which is an insulator serves as a charge barrier. The accumulated charges neutralize the electric field between the electrodes by the electric field generated from the accumulated charges. Therefore, near the driving internal electrode 101a where discharge was first started, discharge in discharge gas cannot be maintained, and the discharge stops.

As a result, the charges (referred to as “residual charges”) remaining in the space without drifting in the plasma generated by the initial discharge are present in a state similar to the so-called pulse after-glow plasma. The plasma behaves like a conductor having a finite electric resistance. Thus the leading end portion A of the residual charges become a pseudo internal electrode having a potential lower than the potential of the driving internal electrode 101a by the voltage drop across the residual charges.

On the other hand, since in the region ahead of the leading end portion A of the residual charges, charges are not accumulated in the tube wall of the discharge tube 102, the discharge can be started by the electric field caused by potential difference between the leading end portion A of the residual charges and the external electrode 103. Therefore, until the potential in the leading end portion A of the residual charges becomes lower than a discharge start voltage by the voltage drop in the plasma, or until the leading end portion A of the residual charges reach the end portion of the discharge tube 102, the discharge develops while repeating the above process in every small distance in the longitudinal direction, extending the plasma of the residual charges. Since the extending speed is usually very fast (more than 1×10⁶ m/sec), at a frequency of about 20 kHz as in the present embodiment, a pulse-shaped lamp current flows immediately after the polarity of applied voltage is inverted. Almost no current flows in a half period until the polarity is inverted again (about 25 microseconds), and this period is a discharge stop period.

After completion of discharging, until the polarity of the applied voltage is inverted again, since the accumulated charges are maintained by the applied voltage, the discharge tube 102 is free from effective electric field. However, it takes more than scores of microseconds until the residual charges are lost completely (due to volume recombination and ambipolar diffusion), and some residual charges are left over at the time of next inversion of polarity.

The ultraviolet emission for exciting the phosphors in a rare gas fluorescent lamp using xenon mentioned above includes bright resonance line emission of 147 nm radiated from xenon excited atom, and continuum emission having a peak at 172 nm radiated when xenon excimer is dissociated. In particular, continuous radiation from excimer is high in efficiency, and therefore it is important for enhancing the lamp efficiency to generate the continuous radiation from excimer effectively. The excimer is generated by collision reaction of one xenon atom in excited state and two xenon atoms in ground state (three-body collision process). The xenon excited atom requires a higher energy for excitation than the mercury used in the general fluorescent lamp. For efficient production of xenon excited atom, a higher energy of electron (higher electron temperature) in the plasma is needed. Therefore, in the resonance line emission of 147 μm, electrons are accelerated in high electric field, and mainly pulsed radiation occurs when the polarity of the applied voltage is inverted.

On the other hand, since electrons are not present in the three-body collision process, formation of excimer and 172 nm continuous radiation continue after completion of discharge. If an electron current is present, the xenon excited atom once excited is easily ionized by collision against an electron of relatively low energy (cumulative ionization), and the forming efficiency of excimer is lowered in a plasma of high current density. Therefore, the lower current density is desired from the viewpoint of efficiency of continuous radiation from the excimer.

Applying the above discussion to the rare gas fluorescent lamp of the invention having the configuration shown in FIG. 1, it is estimated that the luminance distribution in the longitudinal direction became non-uniform due to the following factors.

When the applied voltage is low, at the opposite side of the driving internal electrode 101a, the luminance is lowered by the drop of the plasma potential contributing to the development of discharge. To the contrary, when the applied voltage is raised, the efficiency is lowered by the excessive current near the driving internal electrode 101a. That is, if it is attempted to progress the discharge further merely by raising the applied voltage, the current density elevates near the driving internal electrode 101a, and the ultraviolet emission efficiency drops, lowering the luminance. If much plasma of residual charges exist upon inversion of polarity of the applied voltage, the inside space of the discharge tube 102 has small electric resistance, and the current density becomes high at the time of discharge. In an extreme case, the discharge shrinks to be filamentary, and a streamer state (constricted state) may be observed. As known from the above discussion, in such state, the electron temperature is low, and the xenon excitation efficiency drops and the cumulative ionization is dominant, and hence the radiation efficiency of ultraviolet emission drops. In particular, at the opposite side end of the driving internal electrode 101a, the electric field intensity drops due to excessive presence of residual charges. Hence, even if the applied voltage is raised, the luminance is not increased sufficiently, and the applied voltage must be further raised.

The life of the residual charge is determined almost by the composition and pressure of the discharge gas. However, since the composition and pressure of the discharge gas are also related to the light emission efficiency and the lamp life, they cannot be determined independently. Accordingly, to decrease the residual charges sufficiently when inverting the polarity of the applied voltage generated by pulse discharge, it seems effective to wait until the residual charges recombine to disappear, that is, to prolong the discharge stop period by lowering the driving frequency. However, when the driving frequency is lowered, the number of times of discharge per unit time is decreased and the light emission quantity drops so that the light output from the lamp becomes smaller. Hence, to keep a required quantity of light, the number of lamps must be increased, and hence it is not practical to lower the frequency extremely.

The inventors of the present invention, on the basis of the discussion of physical process explained above, considered means of controlling positively the residual charges in the discharge tube 102 without waiting for spontaneous extinction. As a result, the inventors have concept provision of the internal charge discharge element according to the present invention.

FIG. 4 is a schematic diagram of configuration of the rare gas fluorescent lamp shown in FIG. 1. As shown in the figure, since in the rare gas fluorescent lamp according to the present embodiment of the invention, the flat conductive member 104 is set at floating potential (not grounded), a parallel flat capacitor Cx is composed of the conductive member 104 and external electrode 103. The capacitor Cx acts as a capacitive element X for adjusting internal charge. Therefore, when the plasma of the residual charges extending in the mechanism as explained above reaches the end portion of the discharge tube 102, it contacts with the adjusting internal electrode 101b. Seen from the plasma, outside of the discharge tube 102, the capacitor Cx seems to be connected in series to the plasma (connected in parallel by way of the resistance of the plasma to the lamp capacity Y falsely composed of the driving internal electrode 101a, plasma, and external electrode 103). Accordingly, the electric charge allowed by the electrostatic capacity of the parallel flat capacitor Cx composed of the conductive member 104 and the external electrode 103 is accumulated in the capacitor Cx, and hence the electric charge is discharged from the internal space of the discharge tube 102. As a result, even near the adjusting internal electrode 101b, decline of electric field intensity can be suppressed, and the luminance can be enhanced near the end of the adjusting internal electrode 101b. Moreover, since the discharge can be developed even by a relatively low applied voltage, the decline of efficiency due to elevation of current density near the driving internal electrode 101a can be suppressed. Therefore, the luminance distribution in the longitudinal direction can be made uniform at a lower driving voltage. The potential of the conductive member 104 is preferred to be a floating potential, not clipped to other potential. When the plasma is extended, the potential of the conductive member 104 becomes equal to the plasma potential (strictly saying, there is a difference corresponding to a sheath potential), so that the charge is discharged sufficiently and smoothly and the driving voltage and current may be balanced easily.

The adjusting internal electrode 101b is connected to the conductive member 104 at outside, and is exposed to inside of the discharge tube 102, and is maintained at a potential nearly equal to the residual charge plasma in the discharge tube 102 both in the stop period and in discharge progress. Hence, the discharge is mainly limited to dielectric barrier discharge between the driving internal electrode 101a and the external electrode 103, and the adjusting internal electrode 101b may be considered not to contribute to the discharge.

Further effects obtained by the configuration of the present embodiment are explained below with reference to FIG. 2 again.

In FIG. 2, with the applied voltage of 2.4 kV₀₋ₚ, according to the conventional lamp not provided with conductive member 104, as indicated by curve P1, the distribution shows that the luminance is lower near the driving internal electrode 101a and higher at the opposite side of the internal electrode 101a. At this time, the slope is worse to be +0.00169. This is because the applied voltage is excessive, and the discharge state is shrunk near the driving internal electrode 101a, and the ultraviolet emission efficiency is extremely lowered, causing the luminance to be also lowered. On the other hand, according to the lamp of the invention provided with the conductive member 104, similarly, when 2.4 kV₀₋ₚ is applied, the overall luminance is raised, while the flatness of luminance distribution is maintained, as indicated by curve Q1. At this time, the value of the slope is +0.00065, which is very excellent. Accordingly, in the conventional case without conductive member 104 (see curve P1), a favorable range of luminance slope with respect to the applied voltage is narrow, and the luminance slope varies continuously along with the change in the applied voltage. To the contrary, in the invention provided with the conductive member 104 (see curve Q1), a favorable luminance distribution is maintained over a range higher than a predetermined voltage (nearly higher than 2.0 kV₀₋ₚ in the preferred embodiment). That shows that, in the light of the product design, provision of the conductive member 104 allows stability of luminance distribution characteristic with respect to the applied voltage to be raised, which is a great advantage. Further, when used as backlight for television, the luminance distribution is not broken even at the time of controlling so that the luminance may be enhanced by increasing the applied voltage depending on the scene of the video.

Further according to the configuration of the present embodiment, it is enough to make use of an ordinary process of manufacturing a cold cathode fluorescent lamp to fabricate the discharge tube 102 provided with electrodes at both ends, and to connect the conductive member 104 to one electrode to form the adjusting internal electrode 101b with the other electrode used as the driving internal electrode 101a. Compared to the case of using circuit elements as internal charge discharge element (for example, a capacitor with high rating voltage and small capacity), the structure is very simple and great effects are obtained as mentioned above without largely modifying the process in mass production. Therefore, the cost increase can be suppressed to minimum.

As a result of multiple experiments, preferable internal charge discharge element in the present embodiment includes a conductive member 104 which is flat-shaped, has an area of 1 cm² and a distance of about 4.5 mm between the conductive member 104 and the external electrode 103. In this case, the electric capacity is about 0.2 pF based on the result of measurement. The measuring method of the electric capacity is explained below.

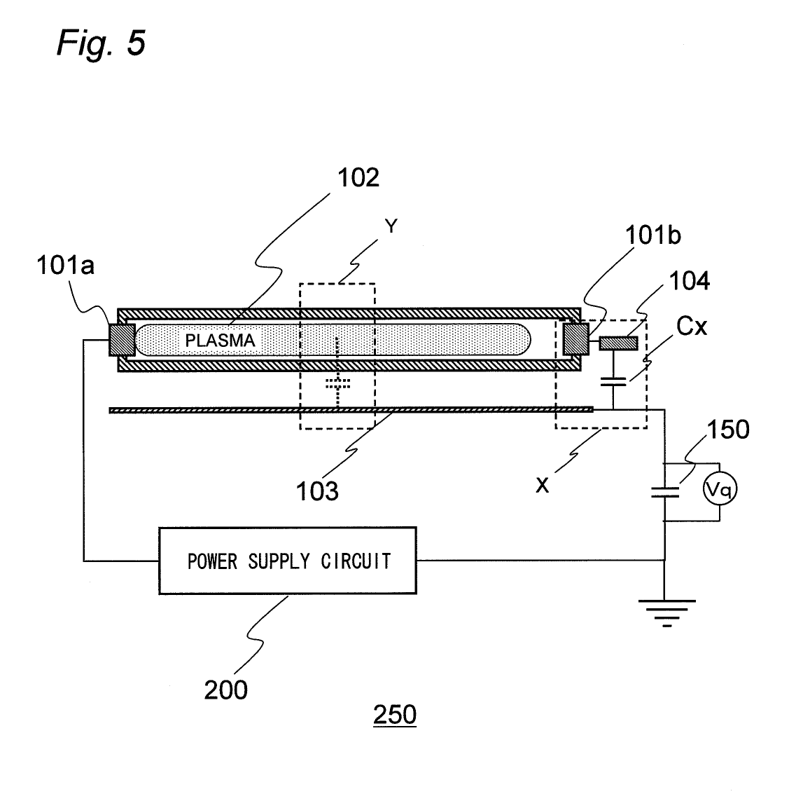

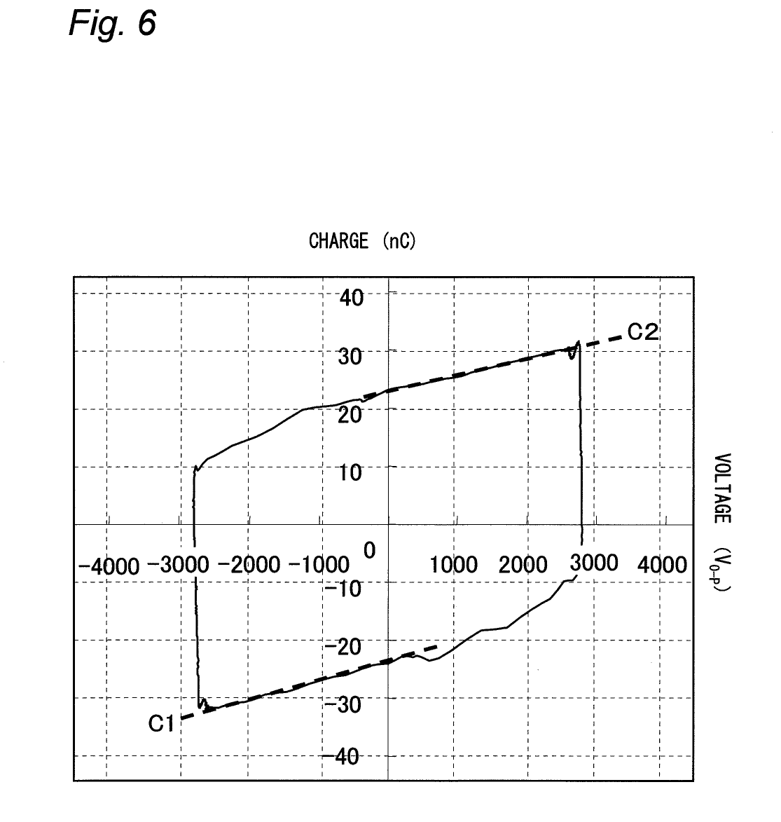

As shown in FIG. 5, a power measuring capacitor 150 is inserted between the external electrode 103 and the grounding terminal of a power supply circuit 200, and then the voltage Vq across the power measuring capacitor 150 is measured. The charge amount accumulated in the external electrode 103 is known from the capacity of the power measuring capacitor 150 and the measured value of Vq. This accumulated charge amount is the integrated value of the current, and a diagram with hysteresis for charge and discharge of lamp is obtained by drawing a graph (V-Q Lissajous' diagram) as shown in FIG. 6, plotting the applied voltage V on the axis of abscissas and the accumulated charge Q on the axis of ordinates. The lamp power per period of voltage waveform is obtained by determining the area of the graphic pattern. At this time, the slopes of lines fitting the upper and lower lines of the graphic pattern represent physical value of the charge divided by the voltage. Hence the slopes are considered to represent quantity equivalent to the capacity. This quantity includes not only a geometrical quantity of the discharge tube 102 and the external electrode 103, but also effects of the current due to the discharge when lighting up the lamp. Hence, in order to minimize the effects of the discharge, only the portion right after voltage inversion is taken out, and slope C1 for inversion of the driving internal electrode 101a from cathode to anode, and the slope C2 for reverse inversion from anode to cathode are determined. Based on results of multiple experiments, the values of C1 and C2 are hardly change if the applied voltage or frequency is changed, and thus they may be approximately considered to reflect the geometrical capacity of the lamp.

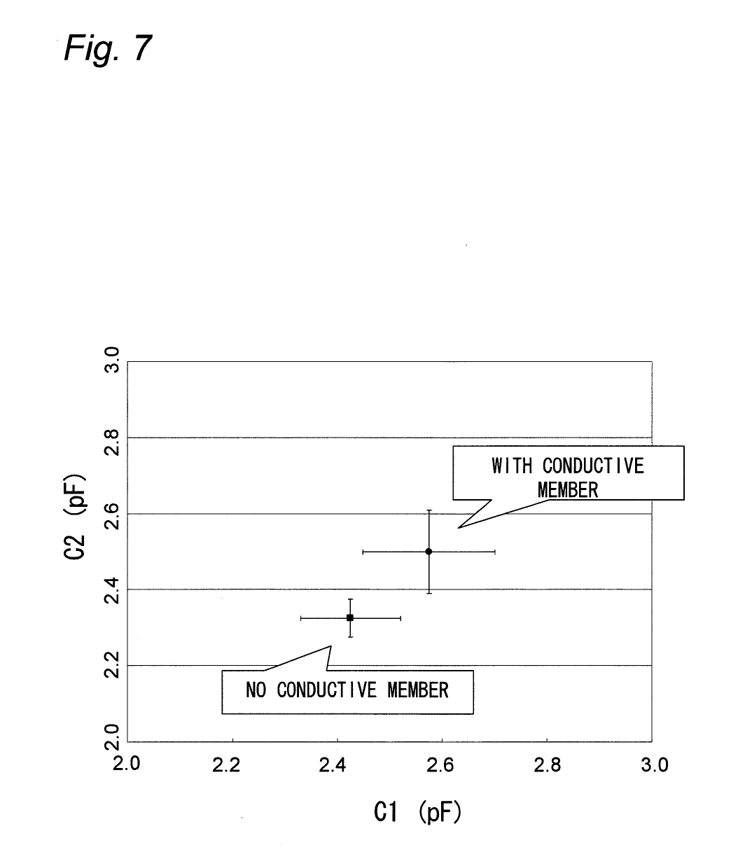

FIG. 7 shows results of measurement of geometrical capacities C1 and C2, comparing between the case with the conductive member 104 (area 1 cm², distance 3 mm from external electrode 103) according to the configuration in the first embodiment and the case without the conductive member 104. The error bar shows the standard deviation of measured results of plural samples. As known from FIG. 7, when provided with the conductive member 104, both values of C1 and C2 are increased, and the increment is about 0.2 pF. This result coincides with the calculated result by assuming a parallel flat capacitor as mentioned above. The reason of difference between values of C1 and C2 is because of difference in the mobility, since the moving charges (electrons or ions) are different depending on the polarity of the driving internal electrode 101a.

Of course, the required capacity Cx of the internal charge discharge element can be varied depending on various conditions, and hence the dimension of the conductive member 104 can be also changed. Increasing the area of the conductive member 104 and shortening the distance from the external electrode 103 allows the capacity Cx of the internal charge discharge element to be increased, increasing the charge amount to be discharged. As a result, it is possible to obtain the effect that makes the luminance distribution uniform even at a lower applied voltage.

However, at the same time, the discharge current increases, and the overall emission efficiency is lowered. For example, according to the experiment by the inventors of the present invention in which the area is varied with the distance fixed at 4.5 mm in the preferred embodiment, the efficiency is lowered by about 10% in the area of about more than 4 cm². On the other hand, when the area of the conductive member 104 is too small, the effect for making uniform the luminance distribution is not obtained sufficiently.

The inventors have performed further experiments by varying the length of the discharge tube 102 and the distance between the discharge tube 102 and the external electrode 103, and studied the balance among effects of lowering of efficiency, uniform luminance in the longitudinal direction, and suppression of driving voltage. Then the inventors have discovered that a favorable range of electric capacity Cx of the internal charge discharge element is from 0.1 pF to 10 pF. If smaller than this range, the luminance distribution can not be uniform, or if larger than this range, the efficiency may drop and the light emission can not be stable, and flickering or worsening of characteristic is observed. Such favorable electric capacity may be realized arbitrarily by combination of area of conductive member 104 and distance from the external electrode 103, because the internal charge discharge element is a parallel flat capacitor.

The material of the conductive member 104 is not limited to aluminum, which can be metal. Instead of the conductive member 104, although not common, a capacitor element with high rating voltage and a capacity in a favorable range can be used.

The internal electrode 101 is a cup-shaped cold cathode, but the shape is not limited to this. The simpler shape can be applied, which can reduce cost, and the loss due to cathode decline may be reduced by coating with an emitter material. Similarly, regarding the external electrode 103, it is an aluminum flat plate with high luminance reflection coating in the present embodiment. However it may be formed of other material having a sufficient electric conductivity. For example, the discharge tube 102 may be formed in nearly a parabolic shaped and placed near the focus, which can enhance luminance on front. The surface of the external electrode 103 may be also formed as a diffusion plane.

### Second Embodiment

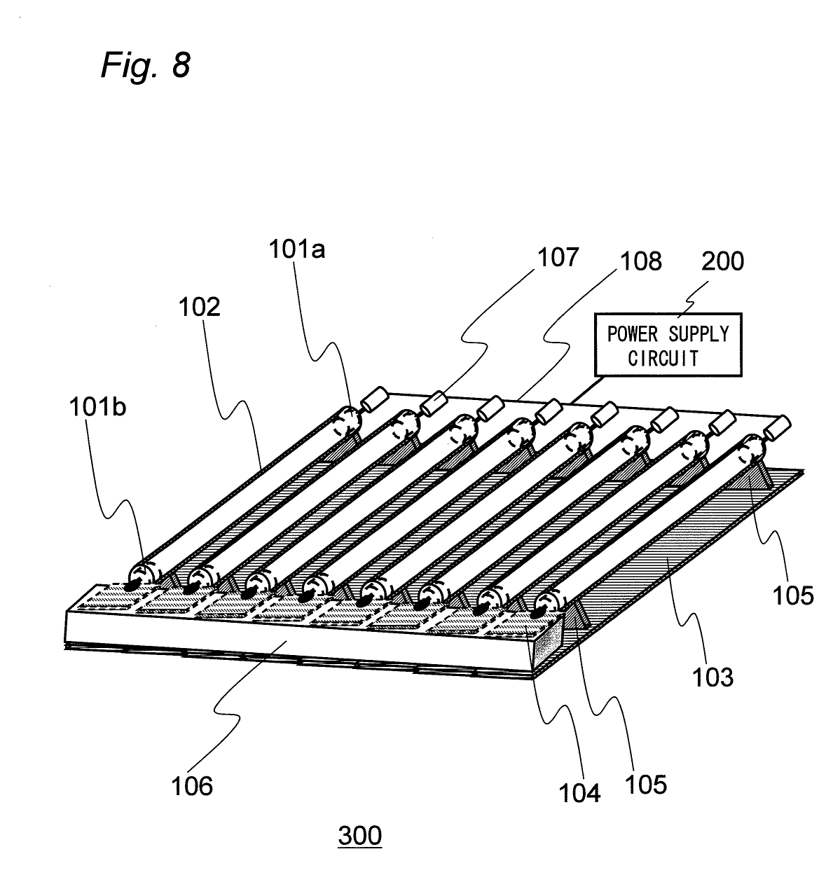

FIG. 8 is a diagram showing a configuration of a light-emitting section in a liquid crystal display backlight unit using the rare gas fluorescent lamps of the first embodiment.

A liquid crystal display backlight unit 300 shown in FIG. 8 has a configuration in which a plurality of rare gas fluorescent lamps 10 shown in the first embodiment are connected in parallel. A discharge tube 102 is directly supported by a spacer 105 for maintaining a specified distance (about 3 mm in the present embodiment) from an external electrode 103. A support member 106 such as resin block or other dielectric material is inserted between a conductive member 104 of the discharge tube 102 and the external electrode 103. The conductive member 104 is adhered to the upside of the support member 106, defining the position of the discharge tube 102. In the present embodiment, the support member 106 is made of epoxy resin with a relative permittivity of about 3.0. Therefore, compared to the structure without support member 106, the same effects are obtained if the area of the conductive member 104 is set to ⅓. When the dielectric barrier discharge is utilized as in the case of rare gas fluorescent lamp of the invention, the overall load of the lamp as seen from the power supply circuit 200 is capacitive. Hence, in the invention, since the current flowing in each lamp is limited by the load capacity, unlike the ordinary cold cathode lamps showing a negative characteristic in current and voltage, a plurality of lamps can be lit (driven) by a single power supply circuit 200. Hence, in the present embodiment, the driving internal electrodes 101a are connected to a common power line 108 by way of a connector 107, and are driven by the single power supply circuit 200. On the other hand, the conductive member 104 is independent for each lamp. This is intended to avoid concentration of current to a lamp which lights first if the timing of discharge progress is deviated due to fluctuations of the lamps.

In the present embodiment shown in FIG. 8, eight lamps are lighted, but the number of lamps may be properly increased or decreasing depending on the television screen size and other conditions.

The material of the support member 106 may be selected properly in consideration of electric characteristics, aging effects and other conditions. In such a case, the area of the conductive member 104 and the distance to the external electrode 103 should be also designed appropriately.

Although in the second embodiment the external electrode 103 is a flat aluminum plate, the external electrode may be a conductor which is nearly flat-shaped and is provided for each discharge tube 102. In this case, preferably, all independent external electrodes 103 are set at the same reference potential.

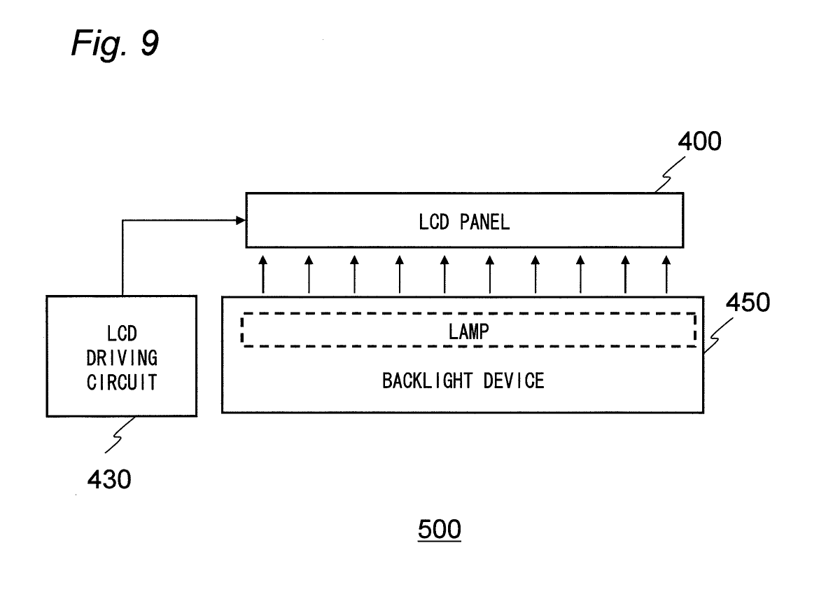

FIG. 9 shows a configuration of a liquid crystal display device making use of the liquid crystal display backlight unit in the second embodiment. A liquid crystal display device 500 includes a liquid crystal display (LCD) panel 400, a liquid crystal display panel driving circuit 430 for driving the liquid crystal display panel depending on the input image signal, and a backlight device 450 for illuminating the liquid crystal display panel 400. The backlight device 450 includes, for example, the liquid crystal backlight unit 300 shown in the second embodiment. In the liquid crystal display device having such configuration, the backlight device 450 can illuminate the liquid crystal display panel 400 with a backlight having uniform luminance distribution in the lamp longitudinal direction. Hence, an image display of high quality free from uneven luminance on the entire screen is realized. Moreover, the backlight device 450 realizes a uniform luminance distribution not depending on the voltage as shown in FIG. 2, and thus an image display of high quality free from uneven luminance is realized even when the luminance is controlled in every scene in the liquid crystal display device.

### INDUSTRIAL APPLICABILITY

The present invention realizes a fluorescent lamp excellent in uniformity of luminance at high efficiency without using mercury, and its utilization. Hence, it is very useful to liquid crystal display backlight, especially to a liquid crystal display backlight for television of wide screen.

1. A lamp lighting apparatus comprising a fluorescent lamp, and a power supply circuit for supplying a driving voltage to the fluorescent lamp, wherein
the fluorescent lamp comprises:
a discharge tube made of transmissive material having a phosphor layer formed on the inner surface of the discharge tube and filled with a discharge gas;
a first internal electrode provided inside the discharge tube and at one end of the discharge tube, for applying a rectangular alternating voltage of high frequency;
a second internal electrode provided inside the discharge tube and at the opposite end the discharge tube to the first internal electrode;
an external electrode provided along the longitudinal direction of the discharge tube; and
a capacitive element for discharging internal charge which is electrically connected to the second internal electrode.

2. The lamp lighting apparatus of claim 1, wherein the capacitance value of the capacitive element for discharging internal charge is in a range of 0.1 pF to 10 pF.

3. The lamp lighting apparatus of claim 1, wherein the capacitive element for discharging internal charge is a conductive member which is disposed oppositely to the external electrode and set at a floating potential.

4. The lamp lighting apparatus of claim 3, wherein a support member made of a dielectric material is placed between the external electrode and the conductive member.

5. The lamp lighting apparatus of claim 1, wherein a plurality of the fluorescent lamps are disposed.

6. The lamp lighting apparatus of claim 5, wherein the capacitive element for discharging internal charge of the fluorescent lamp are insulated electrically for each fluorescent lamp.

7. A fluorescent lamp comprising:
a discharge tube made of transmissive material having a phosphor layer formed on the inner surface of the discharge tube and filled with a discharge gas;
a first internal electrode provided inside the discharge tube and at one end of the discharge tube, for applying a rectangular alternating voltage of high frequency;
a second internal electrode provided inside the discharge tube and at the opposite end the discharge tube to the first internal electrode;
an external electrode provided along the longitudinal direction of the discharge tube; and
a capacitive element for discharging internal charge which is electrically connected to the second internal electrode.

8. A liquid crystal display device comprising
a liquid crystal display panel and a backlight device for illuminating the liquid crystal display panel,
wherein the backlight device includes the lamp lighting apparatus according to claim 1.
